(19) United States
(12) Patent Application Publication
(10) Pub. No.: US 2014/0127072 A1
(43) Pub. Date: May 8, 2014

(54) Continuous sintering method for rare earth permanent magnetic alloy and equipment therefor

(71) Applicant: SHENYANG GENERAL MAGNETIC CO., LTD, Shenyang (CN)

(72) Inventors: Xiaodong Chen, Shenyang (CN); Baoyu Sun, Shenyang (CN)

(73) Assignee: SHENYANG GENERAL MAGNETIC CO., LTD, Shenyang (CN)

(21) Appl. No.: 14/075,732

(22) Filed: Nov. 8, 2013

(30) Foreign Application Priority Data
Nov. 8, 2012 (CN) 201210445514.9
Nov. 8, 2012 (CN) 201210445601.4

(51) Int. Cl. H01F 41/02

(52) U.S. Cl. CPC H01F 41/0253
USPC 419/29; 419/57; 419/60; 432/55; 432/77; 432/200

(57) ABSTRACT

A continuous sintering method for rare earth permanent magnetic alloy comprises: connecting a preparation chamber, a glove chamber and a sealed transmission chamber, a sealed chamber, a charging chamber, a preheating chamber, a heating and de-airing chamber, a sintering chamber and a cooling chamber one after another. A press formed blank of rare earth permanent magnetic alloy powder is transmitted under oxygen free condition, and processed with heating and de-airing, sintering and cooling. The preparation chamber, the glove chamber and the sealed transmission chamber are transmitted by bottom rollers, transmissions of other chambers are provided on a top portion of each chamber, and conveyed by roller rails. The rollers of the charging rack are suspended on rails of the transmissions. The drawer model charging rack is capable of loading multiple charging box.

### BACKGROUND OF THE PRESENT INVENTION

1. Field of Invention

The present invention relates to a continuous sintering method for rare earth permanent magnetic alloy and an equipment therefor, which belongs to the technical field of permanent magnetic alloy treatment equipment and method.

2. Description of Related Arts

R—Fe—B rare earth permanent magnet, with R2Fe14B type compounds as main phase, due to excellent magnetic properties thereof, is widely applied in more and more areas including: medical magnetic resonance imaging, computer hard drives, the vibration motors for mobile phones, motor hybrid cars, as well as wind generators and etc.

The conventional R—Fe—B rare earth permanent magnetic alloy vacuum sintering furnaces are a single-chamber furnace with heating and rapid cooling functions, some sintering furnaces also have a protective atmosphere glove chamber provided thereon. Because the internal heating furnace can only be heated from inside in the vacuum state, the heating speed thereof is slow, and the temperature uniformity deteriorates from long-term utilization; since the heating and cooling process is repeated during every heating, which consumes more inert gas and more energy, and pollutes the heater and the thermal insulation layer, therefore service life of the sintering furnace is shortened.

### SUMMARY OF THE PRESENT INVENTION

In view of the technical problems mentioned above, the present invention provides a continuous sintering method and equipment for rare earth permanent magnetic alloy.

A continuous sintering method for rare earth permanent magnetic alloy according to a preferred embodiment of the present invention, comprises following steps of:

(1) packaging a press formed blank of rare earth permanent magnetic alloy powder to isolate from air, conveying to a preparation chamber, closing a door of the preparation chamber, vacuum pumping or charging insert gas to replace air in the preparation chamber;

when the preparation chamber has a balanced pressure with a glove chamber, opening a 6# isolating valve among chambers, conveying the packaged blank to the glove chamber, closing the 6# isolating valve among chambers; and

unpacking the blank in the glove chamber and putting the blank unpacked into a charging box, opening a 7# isolating valve among chambers, conveying the charging box to a sealed transmission chamber, closing a valve among chambers, conveying the charging box to a manipulator of a charging chamber,

wherein during the process mentioned above, oxygen content of each box and the charging chamber is less than 500 PPm;

(2) conveying a vertical charging rack suspended on a transmission to the charging chamber via a valve of a sealed chamber which is in parallel with the sealed transmission chamber and connected with the charging chamber, putting the charging box into grids of the charging rack, opening a chamber-to-chamber isolating valve after charging, conveying the charging rack suspended to a preheating chamber via the valve, vacuum pumping, heating and maintaining temperature thereof, wherein the heating temperature in the preheating chamber is 400˜500° C.;

(3) opening a 2# isolating valve among a heating and de-airing chamber which is in a vacuum state, conveying the charging rack which is suspended and loaded with the charging box therein to the heating and de-airing chamber, closing the 2# isolating valve, wherein temperature of a heating furnace in this step maintains at 400° C.˜900° C., the heating furnace is capable of processing heating and heat preservation in multiple stage, and has a vacuum degree of over 3 Pa;

(4) opening a 3# isolating valve, conveying the charging rack which is suspended and loaded with the charging box therein to a sintering chamber which is in a vacuum state, closing the 3# isolating valve, and sintering at temperatures of 1020° C.˜1080° C.;

(5) opening a 4# isolating valve among a cooling chamber, conveying the charging rack which is suspended and loaded with the charging box therein to the cooling chamber, closing the 4# isolating valve;

charging the cooling chamber with nitrogen or argon, when a pressure of the cooling chamber is 0.01 MPa˜0.19 MPa, starting a fan for cooling the charging box and the rare earth permanent magnetic alloy therein to a temperature of 80° C. below;

when the pressure of the cooling chamber balances with the atmosphere, opening a discharging end door, conveying the charging rack to a discharging end transition rack, closing the discharging end door, and removing the charging box from the charging rack;

(6) when the charging box is removed from the charging rack, the charging rack enters a charging end transition rack via a loop line and the sealed chamber is charged to be balanced with the atmosphere, opening the charging end door to convey the charging rack to the sealed chamber, closing the charging end door and vacuum pumping to a pressure of 1 Pa, charging insert gas, when the sealed chamber has a balanced pressure with the charging chamber, opening the valve among chambers and conveying the charging rack to the charging chamber again to prepare for loading the charging box.

Preferably, the continuous sintering method for rare earth permanent magnetic alloy further comprises following a step of:

(7) connecting an aging chamber after the cooling chamber via the valve, conveying the charging rack to the aging chamber, heating for 2˜4 hours at a temperature of 800° C.˜900° C., or heating for 2˜6 hours at 450° C.˜550° C.

Preferably, the continuous sintering method for rare earth permanent magnetic alloy further comprises following a step of:

(8) connecting a second cooling chamber 2 after the aging chamber, conveying the charging rack which is suspended and loaded with the charging box therein to the second cooling chamber 2;

charging the cooling chamber with nitrogen or argon, when a pressure of the cooling chamber is 0.01 MPa˜0.19 MPa, starting a fan for cooling the charging box and the rare earth permanent magnetic alloy therein to a temperature of 80° C. below;

when the pressure of the cooling chamber balances with the atmosphere, opening a discharging end door, conveying the charging rack to a discharging end transition rack, closing the discharging end door, and removing the charging box from the charging rack.

A continuous sintering equipment for rare earth permanent magnetic alloy, according to a preferred embodiment of the present invention comprises:

a preparation chamber, a glove chamber and a sealed transmission chamber which are provided one after another, and

a sealed chamber, a charging chamber, a preheating chamber, a heating and de-airing chamber, a sintering chamber and a cooling chamber which are provided one after another,

wherein the sealed chamber, the charging chamber, the preheating chamber, the heating and de-airing chamber, the sintering chamber and the cooling chamber respectively comprise a transmission provided on a top portion thereof,

wherein the charging rack is suspended on the transmission, a manipulator is provided in the charging chamber, each of the chambers are connected via chamber-to-chamber isolating valves, the sealed transmission chamber is connected with the charging chamber,

wherein a number of the preheating chamber, the heating and de-airing chamber, the sintering chamber and the cooling chamber is one or more.

Preferably, the preheating chamber, the heating and de-airing chamber and the sintering chamber all have a vertical cuboid heating furnace provided therein, a thermal insulator is provided on an inner wall of the heating furnace, multiple groups of heaters are provided in the thermal insulator, the transmission is provided on an external of the heating furnace, a first thermal insulation board is provided on a top portion of the heating furnace.

Preferably, the chamber-to-chamber isolating valve is a one-way sealed isolating gate valve, comprising: a valve body, a second air cylinder, multiple air cylinders or oil cylinders, a first valve plate, a front blank flange and a rear blank flange,

wherein the front blank flange and the rear blank flange are respectively provided on two corresponding sides of the valve body, the second air cylinder and a water cooling unit are provided on a top portion of an external of the front blank flange;

wherein the first valve plate which is parallel with two sides of the valve body is provided in the valve body, the first valve plate is suspended on a top portion in the valve body via a valve plate moving device, the valve moving device is rigidly connected with a cylinder end of a rod of the second air cylinder,

wherein a plurality of second rollers and a bottom guide rail are provided on a bottom of the first valve plate, a water cooling pipe or jacket is welded on the first valve plate, the water cooling pipe or jacket is connected with two sealed rigid cooling pipe shafts via a flexible pipe of the water cooling unit, the cooling pipe shafts is connected with the rod of the second air cylinder, so as to achieve a linkage,

wherein the first valve plate is relatively static to the cooling pipe shaft while moving, the multiple air cylinders or oil cylinders are respectively connected with two ends of the first valve plate, so as to lock the first valve plate;

wherein a second magnetic switches is respectively provided on two lines of the air or oil cylinders, so as to control a position of the first valve plate.

Preferably, a second electric motor is provided on a side wall of the cooling chamber, a heat-exchange box is provided in the cooling chamber, a plurality of honeycomb ducts are provided on a plate of the heat-exchange box on a first side, and a second side thereof has a heat exchanger provided thereon, an air outlet of the heat exchanger faces an air outlet of a fan, the fan is connected with a shaft of the second electric motor, an arc guide plate is provided on a periphery of an inner wall of the cooling chamber, an external of the cooling chamber is connected with a vacuum pumping pipe, a insert gas guiding pipe and a safety valve pipe, the vacuum pumping pipe is connected with the 5# vacuum equipment.

Preferably, a wax collecting tank is provided in the preheating chamber for serving as a dewaxing chamber.

Preferably, the transmission comprises a first electric motor, a chain, a gear pair, two bearing chocks, two parallel guide rails, two groups of first rollers, two first sprockets, a second sprocket and a chain plate,

wherein both of the first sprockets are provided on a hinge axis which passes through shell bodies of each chamber and extends outside the shell bodies, an output axis of the first electric motor is connected with the first sprocket via the chain, a first end of the two bearing chocks is respectively provided on a sprocket axis in the shell bodies, and a second end thereof is connected with an axis parallel with the sprocket axis, wherein the both hinge axis and the axis respectively have coupled gear pairs provided thereon, the second sprocket is provided on the sprocket axis inside the shell bodies, the two groups of first roller provided in the two parallel guide rail are connected via a roller axis thereof, the chain plate coupled with the second sprocket is provided on the roller axis, a second end of the chain plate is connected with the connecting rod of the charging rack.

Preferably, the bearing chock is connected with a first end of a spring plate, and a second end of the spring plate is connected with the shell bodies of each chamber, wherein the spring plate bears a force during operation, in such a manner that the second sprocket is closely connected with the chain plate.

Preferably, the preparation chamber, the glove chamber and the tunnel type sealed transmission chamber are all sealed boxes which are vacuum or filled by protective atmosphere, evacuation pipes are provided thereon for connecting the vacuum pumping pipe, and a charging line for insert gas is provided thereon for filling insert gas;

wherein an box-to-box isolating valve is provided between each two adjacent boxes, a first end of the preparation chamber has a box door, a manipulator for putting the charging box onto the charging rack of the charging chamber is provided in the sealed transmission chamber, the pressure gage and the vacuum gauge are provided in each of the box mentioned above, a pipe with balance valve is connected between each adjacent two boxes, so as to balance pressure of the two boxes thereby.

Preferably, the box-to-box isolating valve comprises a valve chamber, a third cylinder and a second valve plate, a hinge plate, a connecting rod, a third roller, a guide rail and a striking block which are provided in the third cylinder,

wherein the second valve plate is connected to the hinge plate via a plurality of connecting rods, a guide rail is provided in the valve chamber, the third roller which is capable of sliding along the guide rail is provided on the hinge plate, the third cylinder is provided on an external of the valve chamber, and a cylinder rod thereof is inserted into the valve chamber to connect the hinge plate, the striking block is provided on a valve deck in the valve chamber, a rubber ring is provided on an end close to a flange beside a valve port on the second valve plate, the third cylinder drives the hinge plate to move along the guide rail, the second valve plate strikes the striking block, the connecting rod pushes the second valve plate to move towards the flange beside the valve port, so as to compress the second rubber ring for accomplishing an effect of isolating and sealing.

Beneficial effects of the present invention are as follows.

1. Compared with the conventional single-chamber vacuum sintering furnace, the present invention allocates the heating, sintering and cooling process to different vacuum chamber, thus the repeated heating and cooling process of the current single sintering furnace is avoided, and the problems of higher energy consumption and low efficiency, as well as the pollution of the heater and the thermal insulation layer are solved; it can also effectively solve the problem of the blank dewaxing, greatly improve production capacity and product consistency under the premise of energy saving, increase equipment service life and reduce equipment maintenance time.

2. Compared with the current continuous vacuum sintering furnace, the present invention is equipped with high and flat charging rack, the height can be more than 1500 mm, and the width is less than 300 mm, therefore it solves the problem of uneven crystal particle size caused by different heat preservation time of the center and the surface of current continuous furnace, and thus solves the problem of poor magnetic consistency.

In addition, the current continuous furnace charges materials from the bottom, in order to ensure the consistency of temperature of the upper and lower parts, the transmission roller is installed inside the thermal insulation layer, and it's made of materials that won't deform at high temperatures; for example, if the temperature is above 800° C., C—C composite, which is expensive and has a short service life, is generally used. The transmitting device of the present invention is set outside of the heating layer, the charging frame hangs while transmitting. In this way the present invention gives a fundamental solution to the shortcomings of bottom transmission, significantly improves product consistency, reduces costs of transmission, and improves its service life.

These and other objectives, features, and advantages of the present invention will become apparent from the following detailed description, the accompanying drawings, and the appended claims.

### BRIEF DESCRIPTION OF THE DRAWINGS

FIG. 1 is a structural sketch view according to a preferred embodiment of the present invention.

FIG. 2 is a sectional sketch view of a heating and de-airing chamber in the FIG. 1.

FIG. 3 is a left sketch view of the FIG. 2.

FIG. 4 is a structural sketch view of a cooling chamber of the FIG. 1.

FIG. 5 is a structural sketch view of a chamber-to-chamber isolating valve between chambers of the FIG. 1.

FIG. 6 is a left sketch view of the FIG. 5.

FIG. 7 is a top sketch view of the FIG. 5.

FIG. 8 is a structural sketch view of a preparation chamber of the FIG. 1.

FIG. 9 is a structural sketch view of a glove chamber of the FIG. 1.

FIG. 10 is a structural sketch view of a box-to-box isolating valve of the FIG. 1.

References of numbers in the drawings: 1—suspension type conveying system; 2—charging rack; 3—charging end transition rack; 4—charging end door; 5—1# vacuum equipment; 6—rough valve; 7—1# rotary piston pump; 8—1# roots pump; 9—1# bypass valve; 10—sealed chamber; 11—charging line; 12—1# pressure gage; 13—vacuum gauge; 14—1# isolating valve; 15—insert gas guiding pipe; 16—preheating chamber; 17—safety valve; 18—flange; 19—main valve; 20—diffusion pump; 21—2# roots pump; 22—2# rotary piston pump; 23—2# bypass valve; 24—2# vacuum equipment; 25—2# isolating valve; 26—heating and de-airing chamber; 27—3# vacuum equipment 28—3# isolating valve; 29—sintering chamber; 30—4# vacuum equipment; 31—4# isolating valve; 32—5# vacuum equipment; 33—fan; 34—cooling chamber; 35—discharging end door; 36—discharging end transition rack; 37—preparation chamber; 38—6# isolating valve; 39—glove chamber; 40—7# isolating valve; 41—sealed transmission chamber; 42—charging box; 43—manipulator; 44—charging chamber; 45—5# isolating valve; 46—safety valve connecting pipe flange; 47—gas filled flange; 48—bearing chock; 49—first sprocket; 50—gear pair; 51—first thermal insulation board; 52—water cooling pipe; 53—first roller; 54—guide rail; 55—exhaust connecting pipe flange; 56—upper thermal insulation layer; 57—thermocouple; 58—water cooled electrode; 59—side thermal insulation layer; 60—heater; 61—lower thermal insulation layer; 62—spring plate; 63—chain; 64—first electric motor; 65—second sprocket; 66—first air cylinder; 67—photoelectric switch; 68—second electric motor; 70—heat exchanger; 71—honeycomb duct; 72—guide plate; 73—second cylinder; 74—first magnetic switch; 75—front blank flange; 76—valve body; 77—second magnetic switch; 78—air cylinder or oil cylinder; 79—first rubber ring; 80—first valve plate 80; 81—second thermal insulation board; 82—rear blank flange; 83—second roller; 84—bottom guide rail; 85—connecting board; 86—cooling pipe shaft; 87—flexible pipe; 88—top rail; 89—hinge connecting plate; 90—box door; 91—1# pipe with discharge valve; 92—1# electric control cabinet; 93—1# inspection window; 94—1# pipe with charge valve; 95—2# pressure gage; 96—chain plate; 97—1# bottom roller transmission; 98—glove and flange unit; 99—2 # inspection window; 100—2# electric control cabinet; 101—2# pipe with discharge valve; 102—2# pipe with charge valve; 103—3# pressure gage; 104—2# bottom roller transmission; 105—third cylinder; 106—third magnetic switch; 107—third roller; 108—guide rail; 109—second rubber ring; 110—a second valve plate; 111—hinge plate; 112—connecting rod; 113—striking block; 114—valve deck 14.

### DETAILED DESCRIPTION OF THE PREFERRED EMBODIMENT

Combined with the accompany drawings and the preferred embodiment Further description of the present invention is illustrated as follows.

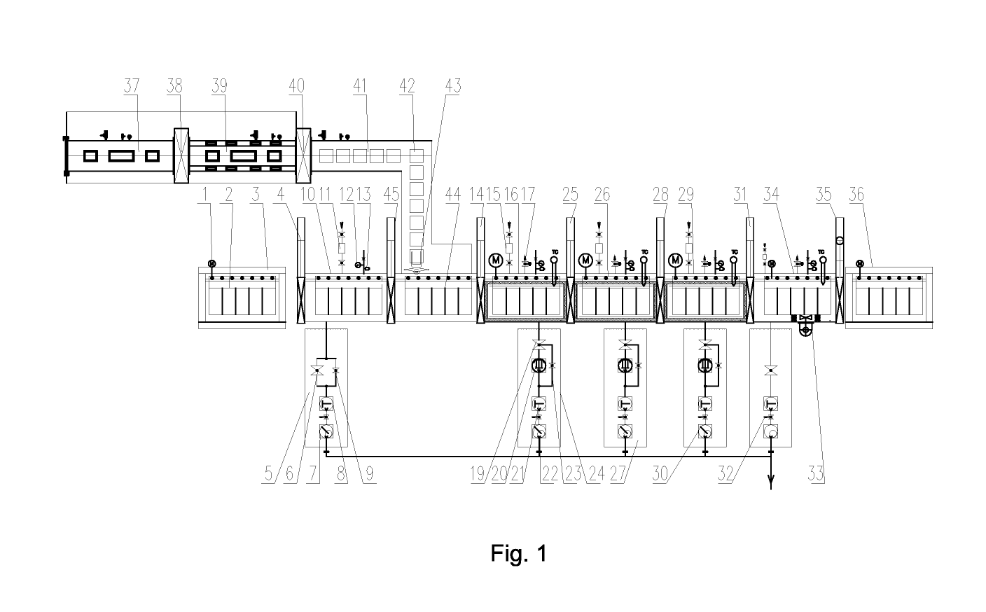

Referring to FIG. 1 of the drawings, a continuous sintering furnace for rare earth permanent magnetic alloy according to a preferred embodiment of the present invention comprises:

a preparation chamber 37, a glove chamber 39 and a sealed transmission chamber 41 which are provided one after another,

a sealed chamber 10, a charging chamber 44, a preheating chamber 16, a heating and de-airing chamber 26, a sintering chamber 29 and a cooling chamber 34, which are provided one after another; transmissions of each chamber, loop-line racks and vacuum extractors of each chamber.

The chambers mentioned above are all connected via isolating valves therebetween. The sealed transmission chamber 41 is connected with the charging chamber 44.

Each transmission of each chamber is provided on a top of each chamber. The loop-line rack is provided outside each chamber and a transmission is provided on the loop-line rack. The transmission of each chamber, the loop-line rack and the transmission provided thereon form a suspension type conveying system 1.

The loop-line rack is connected with a charging end transition rack 3 and a discharging end transition rack 36. A charging rack 2 is suspended on the transmissions and moves back and forth circularly. A charging box 42 is conveyed to the charging rack 2 via the sealed transmission chamber 41. A water cooling pipe 52 or water cooling jacket, a vacuum pumping line, a The preheating chamber 16, a water cooling pipe 52 or water cooling jacket, a vacuum pumping pipe, an insert gas guiding pipe 15, a safety valve 17, a 1# pressure gage 12 and a vacuum gauge 13 are respectively provided on external walls of the preheating chamber 16 the heating and de-airing chamber 26 and the sintering chamber 29.

As shown in FIG. 1 of the drawings, the preparation chamber 37, the glove chamber 39 and the tunnel type sealed transmission chamber 41 are all sealed boxes which are vacuum or filled by protective atmosphere, evacuation pipes are provided thereon for connecting the vacuum pumping pipe, and a charging line 11 for insert gas is provided thereon for filling insert gas. A box-to-box isolating valve is provided between each two adjacent boxes. A first end of the preparation chamber 37 has a box door. A manipulator 43 for putting the charging box onto the charging rack 2 of the charging chamber is provided in the sealed transmission chamber 41, wherein the manipulator 43 is in a conventional structure. The pressure gage 12 and the vacuum gauge 13 are provided in each of the box mentioned above, a pipe with balance valve is connected between each adjacent two boxes, so as to balance pressure of the two boxes. A 1# bottom roller transmission 97, a 2# bottom roller transmission 104 and a transfer charging box 42 are respectively provided in the preparation chamber 37, the glove chamber 39 and the tunnel type sealed transmission chamber 41, wherein the bottom roller transmission, which is a conventional structure, is a transmitting structure with multi-roller side by side.

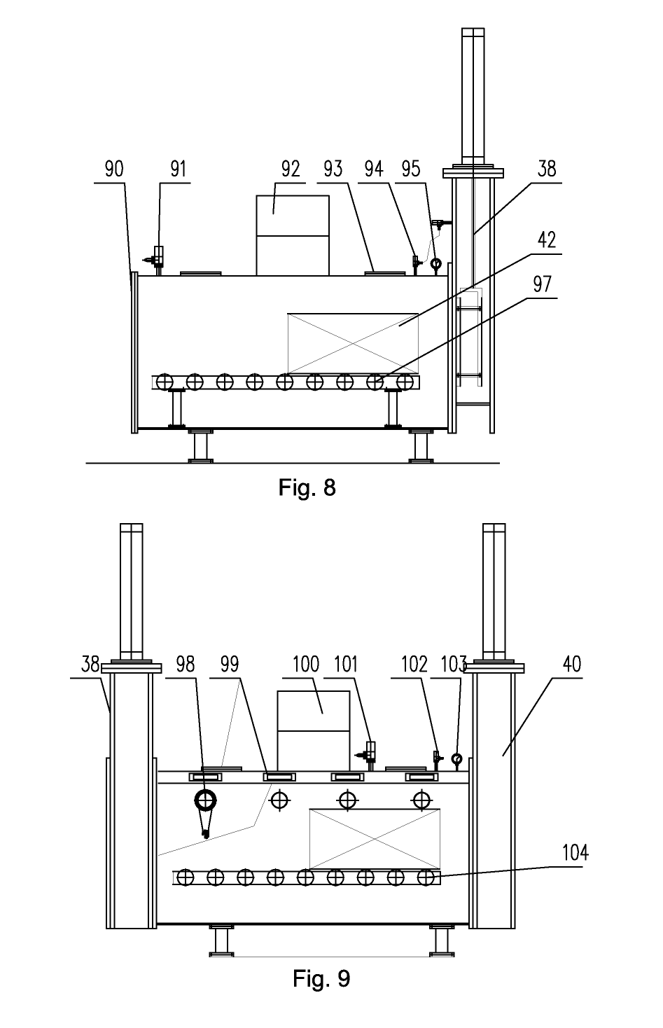

As shown in FIG. 8 of the drawings, the preparation chamber 37 is a vertical sealed square box, wherein a box door 90 is provided on a first end of the preparation chamber 37, and a 6# isolating valve 38 is provided on a second end thereof. A 1# pipe 91 with discharge valve, a 1# electric control cabinet 92, a 1# inspection window 93, a 1# 1# pipe 94 with charge valve, a pipe for balancing gas pressure and 2# pressure gage 95. The charging box 42 in the preparation chamber 37 is transmitted by the 1# bottom roller transmission 104.

As shown in FIG. 9 of the drawings, the glove chamber 39 is a vertical sealed box. A 6# isolating valve 38 is provided on a first end of the glove chamber 39 for connecting with the preparation chamber 37. A 7# isolating valve 40 is provided on a second end of the glove chamber 39. A glove and flange unit 98, a 2# inspection window 99, a 2# electric control cabinet 100, a 2# pipe 101 with discharge valve, a 2# pipe 102 with charge valve and a 3# pressure gage 103 are provided on the glove chamber 39. A 2# bottom roller transmission 104 is provided in the glove chamber 39.

As shown in FIG. 1 of the drawings, the tunnel type sealed transmission chamber 41 is a vertical sealed box, which is connected with a side of the charging chamber 44. The pipe with discharge valve, the pipe with charge valve, the pressure gage and the bottom roller transmission are provided on the tunnel type sealed transmission chamber 41. The tunnel type sealed transmission chamber 41 has the manipulator 43 for putting the charging boxes 42 which are piled up into the suspension type charging rack 2. The bottom roller transmission includes a plurality of rollers side by side for transmitting.

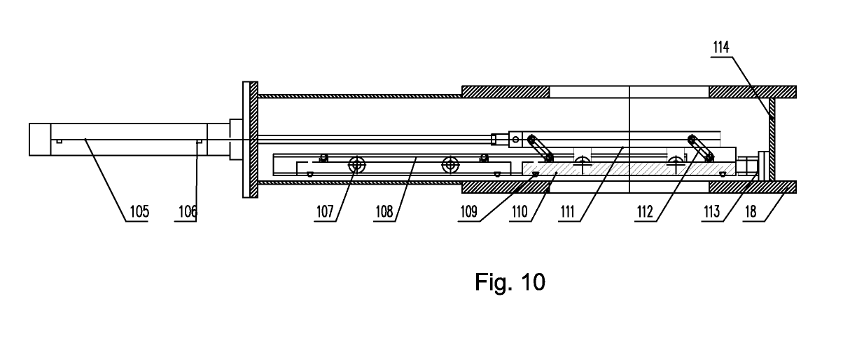

As shown in FIG. 10 of the drawings, the box-to-box isolating valve is in a structure of a one-way sealed gate valve, which comprises a valve chamber, a third cylinder 105 and a second valve plate 110, a hinge plate 111, a connecting rod 112, a third roller 107, a guide rail 108 and a striking block 113 which are provided in the third cylinder 105. The second valve plate 110 is connected to the hinge plate 111 via a plurality of connecting rods 112. A guide rail 108 is provided in the valve chamber. The third roller 107 which is capable of sliding along the guide rail 108 is provided on the hinge plate 111. The third cylinder 105 is provided on an external of the valve chamber, and a cylinder rod thereof is inserted into the valve chamber to connect the hinge plate 111. The striking block 113 is provided on a valve deck 114 in the valve chamber. A rubber ring 109 is provided on an end close to a flange 18 beside a valve port on the second valve plate 110. The third cylinder 105 drives the hinge plate 111 to move along the guide rail 108. The second valve plate 110 strikes the striking block 113. The connecting rod pushes the second valve plate to move towards the flange 18 beside the valve port, so as to compress the second rubber ring 109 for accomplishing an effect of isolating and sealing, A third magnetic switch 106 is provided on the third cylinder r105, so as to indicate a moving position of the second valve plate 110.

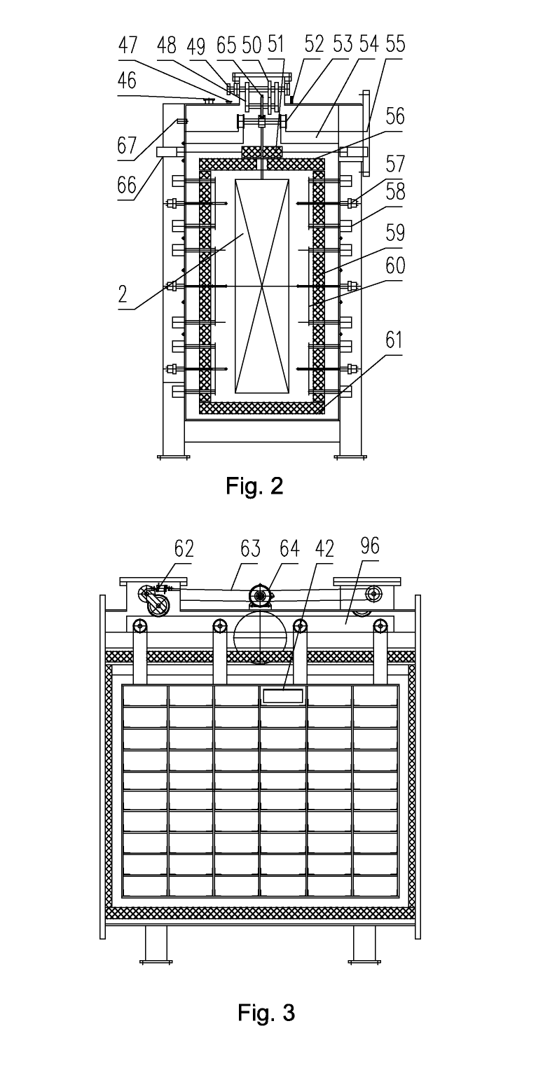

The preheating chamber 16, the heating and de-airing chamber 26 and the sintering chamber 29 all have a vertical cuboid heating furnace provided therein. As shown in FIG. 2 and FIG. 3 of the drawings, a thermal insulator is provided on an inner wall of the heating furnace, wherein the thermal insulator comprises an upper insulation layer 56 and a lower insulation layer 61 and two side insulation layers 59. Multiple groups of heaters 60 are provided in the thermal insulator. A thermocouple 57 is provided on each group of the heater 60, and temperatures are respectively controlled in each group. The transmission is provided on an external of the heating furnace. A first thermal insulation board 51 capable of opening and closing left and right is provided on a top portion of the heating furnace. Both sides of the insulation board 51 are respectively connected with a first air cylinder 66. During operation hours, the first air cylinder 66 controls opening and closing of the first thermal insulation board 51. The charging rack 2 is provided in the heating furnace, and one end thereof passes through the insulation board 51 and is suspended on the transmission. A photoelectric switch 67 is provided on a side wall of the heating furnace, so as to control a moving position of the charging rack 51.

As shown in FIG. 2 and FIG. 3 of the drawings, according to a preferred embodiment of the present invention, the transmission comprises a first electric motor 64, a chain 63, a gear pair 50, two bearing chocks 48, two parallel guide rails 54, two groups of first rollers 53, two first sprockets 49, a second sprocket 65 and a chain plate 96. Both of the first sprockets 49 are provided on a hinge axis which passes through shell bodies of each chamber and extends outside the shell bodies. An output axis of the first electric motor 64 is connected with the first sprocket 49 via the chain 63. A first end of the two bearing chocks 48 is respectively provided on a sprocket axis in the shell bodies, and a second end thereof is connected with an axis parallel with the sprocket axis, wherein the both hinge axis and the axis respectively have coupled gear pairs 50 provided thereon. The second sprocket 65 is provided on the sprocket axis inside the shell bodies. The two groups of first roller 53 provided in the two parallel guide rail 54 are connected via a roller axis thereof. The chain plate 96 coupled with the second sprocket 65 is provided on the roller axis. A second end of the chain plate 96 is connected with the connecting rod of the charging rack. The bearing chock 48 is connected with a first end of a spring plate 62, and a second end of the spring plate 62 is connected with the shell bodies of each chamber, wherein the spring plate bears a force during operation, in such a manner that the second sprocket 65 is closely connected with the chain plate 96.

The sealed chamber 10, which is a vertical box, is a converter of vacuum and the atmosphere. An insert gas guiding pipe 15 and a 1# vacuum equipment 5 are provided on the sealed chamber 10. The 1# vacuum equipment 5 comprises a rough valve 6, a 1# rotary piston pump 7 or rotary vacuum pump, 1# roots pump 8, 1# bypass valve 9 and a vacuum pump. The charging rack 2 loads the charging box 42 and is vertically suspended on the transmission, driven by a reducer of a second electric motor 68 of the transmission, and transported via the transmission. The photoelectric switch 67 displays and controls a position of the charging rack. Thus, the second electric motor 68 of the transmission achieves frequency control.

The charging chamber 44 is a vertical box. A 5# isolating valve 45 is provided on a first end of the charging chamber 44 and connected with the sealed chamber 10. A 1# isolating valve 14 is provided on a second end of the charging chamber 44 and connected with the preheating chamber 16. A side face of a body of the charging chamber 44 is connected with the tunnel type sealed transmission chamber 41. The manipulator 43 in the tunnel type sealed transmission chamber 41 puts a plurality of charging boxes 42 which are piled up onto the suspension type charging rack 2. An insert gas guiding pipe 15 is provided on the charging chamber 44. The charging rack 2 loads the charging box 42 and is suspended on the transmission. The photoelectric switch 67 displays and controls a position of the charging rack 2. Thus, the second electric motor 68 of the transmission achieves frequency control.

The preheating chamber 16, the heating and de-airing chamber 26 and the sintering chamber 29 all have a vertical cuboid heating furnace provided therein. The upper thermal insulation layer 56, the side thermal insulation layers 59 and the lower thermal insulation layer 61 are provided inside the heating furnace. Multiple groups of heaters 60 are provided inside the thermal insulation layers, which are leaded to exterior of the chamber via a water cooled electrode 58 for connecting with a heating power source. Each group of heaters 60 has a thermocouple 57 connected with a temperature control computer in a electric control case, so as to control an output power of the external power source of the heaters, so as to accomplish controlling temperature in separate zones of the heaters. The transmission is outside the heaters. The first thermal insulation board 51 capable of opening and closing left and right is provided on a top of the heaters. The first air cylinders 66 are respectively connected with two sides of the first thermal insulation board 51, so as to drive the first thermal insulation board 51 capable of opening and closing left and right to move. When the charging rack 2 moves, the first thermal insulation board 51 is opened; and when the charging rack 2 standstills in the heating furnace, the first thermal insulation board 51 is closed. The two parallel guide trails 54 of the transmission are provided on a side wall of the chambers on an external top of the heating furnace. The multiple first rollers 53 connected with the charging crack 2 are suspended on the guide rail 54. The reducer of the first electric motor 64 outside the chamber transmits driving force to a transmitting sealed sprocket axis inside the chamber via the chain 63 of the sprocket. The gear pair 50 which bears force via a spring plate 62 transmits a torque to the first sprocket 49. Bearing chocks 48 are provided on two end of the gear pair 50. The first sprocket 49 drives the chain plate 96 on the charging rack 2 to move, so as to drive the charging rack 2 to move.

The preheating chamber 16 is a vertical box, wherein the water cooling pipe 52 is provided on an external wall thereof, an exhaust connecting pipe flange 55 provided thereon is connected with a 2# vacuum extractor, a gas filled flange 47 provided thereon is connected with the insert gas guiding pipe 15, and a safety valve connecting pipe flange 46 is connected with the safety valve 17. The charging rack 2 loads the charging box 42 and is suspended on the transmission and transmitted by the guide rail thereof. The photoelectric switch 67 is provided on a side plate symmetrical to a top of the body of the preheating chamber, and displays and controls a position of the charging rack 2, so as to achieve frequency control. A wax collecting tank is matched with the preheating chamber, and the insulation layer covered on an external of the chamber can serve as a de-waxing chamber.

All of the vacuum equipments are in conventional structure. The 2# vacuum equipment 24, 3# vacuum equipment 27 and the 4# vacuum equipment 30 all have the same structure, which comprises: a main valve 19, a diffusion pump 20, a 2# roots pump 21, a 2# rotary piston pump 22, a 2# bypass valve 23 and a vacuum pipe. The 1# vacuum equipment 5 comprises the rough valve 6, the 1# bypass valve 9, the 1# rotary piston pump 7 and the 1# roots pump 8. The 5# vacuum equipment 32 comprises the rotary piston pump, the roots pump 8 and the main valve.

As shown in FIG. 2 and FIG. 3 of the drawings, the heating and de-airing chamber 26 is a vertical box. The water cooling pipe 52 or the water cooling jacket is provided on an external wall of the heating and de-airing chamber 26. The 3# vacuum equipment 27, the insert gas guiding pipe and the safety valve are connected with the heating and de-airing chamber 26. The charging rack 2 loading the charging box 42 is vertically suspended on the transmission thereof and transmitted by the guide rail. An opposite-type photoelectric switch 67 is provided on a top of a side plate symmetrical with the heating and de-airing chamber outside the heating furnace, so as to display the position of the charging rack 2 and achieve frequency control.

The sintering chamber 29 is a vertical box. The water cooling pipe is provided on an external wall of the sintering chamber 29. The 4# vacuum equipment 30, the insert gas guiding pipe and the safety valve are connected with the sintering chamber 29. The charging rack 2 loading the charging box 42 is vertically suspended on the transmission thereof and transmitted by the guide rail. A photoelectric switch 67 is provided on a top of a body of the sintering chamber 29, so as to display the position of the charging rack 2 and achieve frequency control.

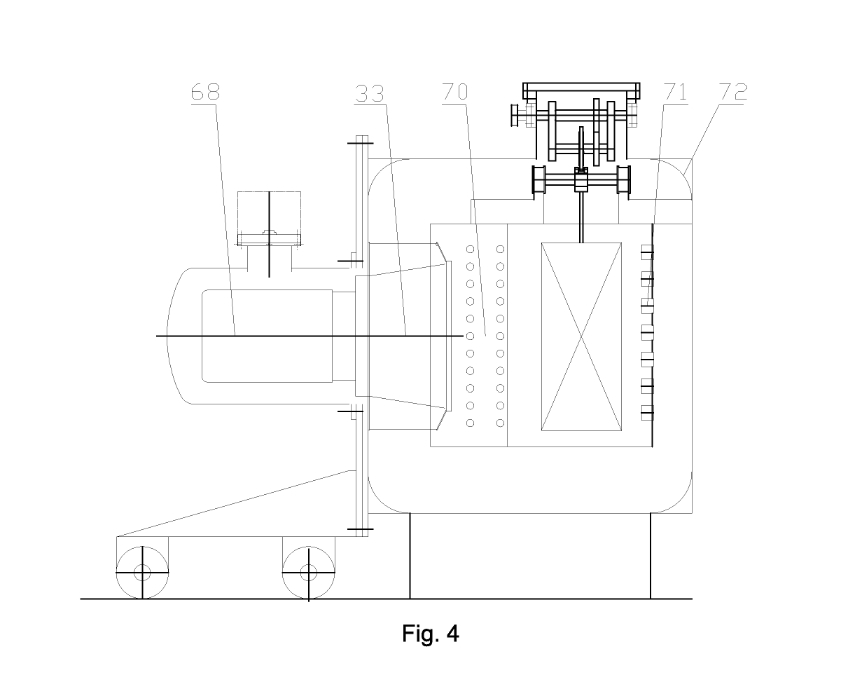

As shown in FIG. 4 of the drawings, the cooling chamber 34 is a vertical box. A water cooling pipe is welded on an external wall of the cooling chamber 34. The second electric motor 68 is provided on a side wall of the cooling chamber 34. A heat-exchange box is provided in the cooling chamber 34. A plurality of honeycomb ducts 71 are provided on a plate of the heat-exchange box on a first side, and a second side thereof has a heat exchanger 70 provided thereon. An air outlet of the heat exchanger faces a fan 33. The fan 33 is connected with a shaft of the second electric motor 68. An arc guide plate 72 is provided on a periphery of an inner wall of the cooling chamber 34. An external of the cooling chamber 34 is connected with a vacuum pumping pipe, a insert gas guiding pipe and a safety valve pipe. The vacuum pumping pipe is connected with the 5# vacuum equipment 32. The charging rack 2 loading the charging box 42 is vertically suspended on the transmission. A photoelectric switch 67 is provided thereon to display the position of the charging rack 2 and achieve frequency control.

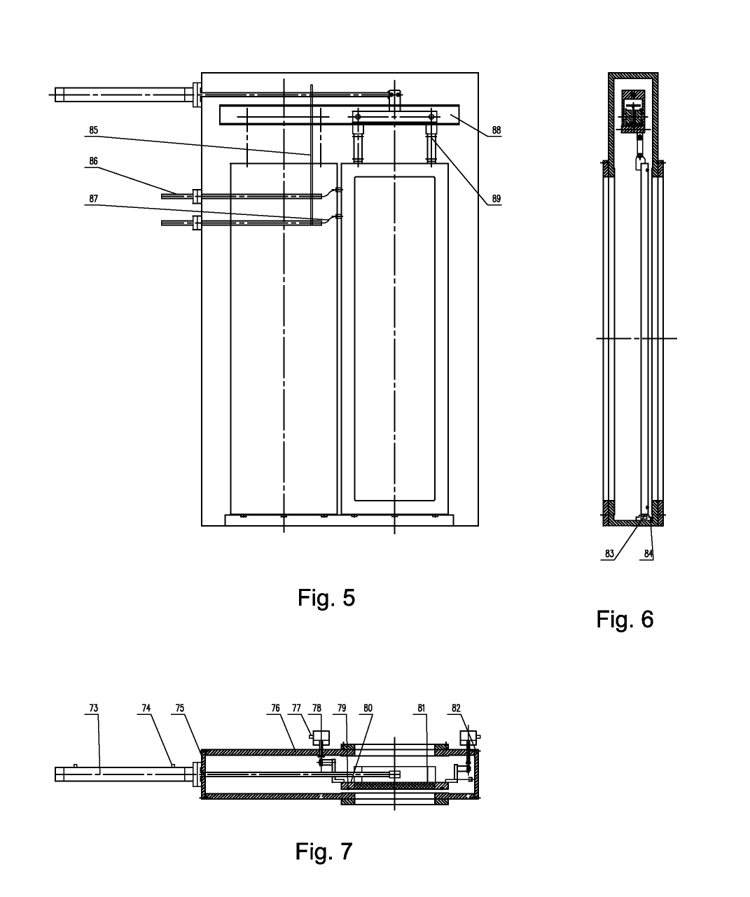

The chamber-to chamber isolating valve is a one-way sealed isolating gate valve. As shown in FIGS. 5-7 of the drawings, the chamber-to chamber isolating valve comprises: a valve body 76, a second air cylinder 73, multiple air cylinders or oil cylinders, a first valve plate 80, a front blank flange 75 and a rear blank flange 82,

wherein the front blank flange 75 and the rear blank flange 82 are respectively provided on two corresponding sides of the valve body 76, the second air cylinder 73 and a water cooling unit are provided on a top portion of an external of the front blank flange 75;

wherein the first valve plate 80 which is parallel with two sides of the valve body 76 is provided in the valve body 76, the first valve plate 80 is suspended on a top portion in the valve body via a valve plate moving device, the valve moving device is rigidly connected with a cylinder end of a rod of the second air cylinder 73,

wherein a plurality of second rollers 83 and a bottom guide rail 84 are provided on a bottom of the first valve plate 80, a water cooling pipe or jacket is welded on the first valve plate 80, the water cooling pipe or jacket is connected with two sealed rigid cooling pipe shafts 86 via a flexible pipe 87 of the water cooling unit, the cooling pipe shafts 86 is connected with the rod of the second air cylinder 73 via a connecting board 85, so as to achieve a linkage,

wherein the first valve plate 80 is relatively static to the cooling pipe shaft 86 while moving, the multiple air cylinders or oil cylinders 78 are respectively connected with two ends of the first valve plate 80, so as to lock the first valve plate 80;

wherein a second magnetic switches 77 is respectively provided on two lines of the air or oil cylinders 78, so as to control a position of the first valve plate 80.

The valve plate moving device comprises: a top rail 88, a plurality of rollers and a hinge connecting plate 89,

wherein the rollers are provided in the top rail 88 and slides along the top rail 88, the first valve plate 80 is suspended on the top rail 88 via the hinge connecting plate 89 and the rollers, in such a manner that the rollers are capable of sliding on the top rail 88,

wherein a second thermal insulation board 81 is provided on a side of the valve plate corresponding to a valve port,

wherein the rod of the second air cylinder 73 drives the first valve plate 80 to move, and a position of the first valve plate 80 is controlled by a first magnetic switch 74,

wherein the one-way sealed is achieved by multiple air or oil lock cylinder rods impacting on the first valve plate 80.

As shown in FIG. 7 of the drawings, the first valve plate is pushed by multiple air or oil cylinders, so as to guarantee equality force on the first valve plate 80. A first rubber ring 79 for sealing is provided on the first valve plate 80, wherein the first rubber ring 79 has a great compression, so as to guarantee sealing property of the valve plate of a large size valve port. The effect of the front blank flange 75 and the rear blank flange 82 of the valve body 76 is to ensure that the first valve plate 80 is capable of being moved away from a side of the valve body 76 for maintenance.

According to requirements of heating process, a wax collecting tank may be provided in the preheating chamber for serving as a de-waxing chamber.

Working process of the present invention is as follows.

The working process is illustrated as follows with reference to FIG. 1 of the drawings. Check the electric power, gas power source, cooling water circulation and medium gas source. Make sure all main and auxiliary equipments are good and in working condition. Take the decentralized mode of operation to make the equipment meet the requirements of production process, i.e., the vacuum extractor is started and is interlocked, then close the isolating valve between the chambers and the isolating valve between boxes, so the glove chamber, the sealed transit box and the charging chamber are under the protective atmosphere (oxygen content<500 PPm), and the other chambers are in the vacuum state; make sure the furnace heater is intact; inert gas is set to the predetermined value, and all sensors are in a steady and working condition.

Open the box door 90 under atmospheric pressure, charge blank into the preparation chamber 37, close the box door 90, charge the box with inert gas to replace oxygen until oxygen content<500 PPm; maintain pressure balance between the preparation chamber 37 and the glove chamber 39, open the 6 # isolating valve 38, start transmission, charge blank into the glove chamber 39, close the 6 # isolating valve; blank in glove chamber 39, charge the blank into a graphitic charging box, then finish stacking and numbering the charging boxes.

When the pressure between the glove chamber 39 and the sealing transmission chamber 41 is balanced, open the 7# isolating valve 40, start transmission, stacked charging boxes 42 enters the sealed transit box 41, close the 7# isolating valve 40; the charging box 42 in the sealed transit box 42 is transmitted to the manipulator 43 and in waiting.

Open the charging end door 4 under atmospheric pressure, the charging rack 2 waiting at the charging end transition rack 3 enters the sealed chamber 10, close the charging end transition rack 4; the 1# vacuum system 5 vacuums the sealed chamber 10, fill back inert gas when pressure≦5E-2 Pa.

The charging chamber 44 has no charging rack 2 provided therein, maintain pressure balance between the charging chamber 44 with the sealed chamber 10, open the 5# isolating valve 45, the charging rack 2 enters into the charging chamber 44, close the 5# isolating valve 45; the manipulator in the sealed transmission chamber 41 puts the charging box 42 into the charging rack 2.

The preheating chamber 44 has no charging rack 2 therein, maintain pressure balance between the preheating chamber 16 and the charging chamber 44, open the 1# isolating valve 14, the charging rack 2 enters into the preheating chamber 16, close the 1# isolating valve 14; the 2# vacuum equipment 24 vacuums the preheating chamber 24 to 1 Pa, heat to 430° C. according to the required heating rate of the process and preserve the temperature.

The 3# vacuum equipment 27 vacuum-pumps the heating and de-airing chamber 26. Without the charging rack 2 in the heating and de-airing chamber 26, maintain pressure balance between the preheating chamber 16 and the heating and de-airing chamber 26, open the 2# isolating valve 25, the charging rack 2 enters the heating and de-airing chamber 26, close the 2# isolating valve 25, then heat the heating and de-airing chamber 26 to 850° C.

The 4# vacuum equipment 30 vacuum-pumps the sintering chamber 29. Without the charging rack 2 in the sintering chamber 29, maintain pressure balance between the sintering chamber 29 and the heating and de-airing chamber 26, open the 3# isolating valve 28, the charging rack 2 enters the sintering chamber 29, close the 3# isolating valve 28, heat the sintering chamber to 1080° C.

The 5# vacuum equipment 32 vacuum-pumps the cooling chamber 34. When the pressure between the sintering chamber 29 and the cooling chamber 34 balances, and the cooling chamber 34 is without the charging rack 2, open the 4# isolating valve 31, the charging rack 2 enters the cooling chamber 34, close the 4# isolating valve 31. Fill in inert gas, when the pressure reaches 0.01 Mpa, start the fan 33 and begin forced cooling on the charging box and the magnetic block therein.

The charging box 42 and the magnetic block therein is cooled below 80° C., and when the cooling chamber 34 is under atmospheric pressure, open the discharging end door 35, and the charging rack 2 enters the discharging end transition rack 36.

The charging rack 2 enters the charging end transition rack 3 through the loop-line rack, and waits.

The transmission of the charging rack 2 among the chambers is operated by the electric motor driven chains, introducing power to the gear pair 50 in the vacuum chamber box through sealed transmission shaft, then transmit power to the first sprocket 49 through the bearing chock 48 and the gear pair 50, then to the shaft on the charging rack 2 through the spring plate 62; the first roller 53 on the charging rack 2 moves on the guide rail 54, and the photoelectric switch 67 is the limit shift.

In production, the control system is capable of continuously scanning the status of the equipment, and running automatically according to a predetermined program. The whole operation is done on a man-machine interface of a computer.

Electrical control system or the screen thereof is capable of displaying the following information: the vacuum pumps, the vacuum valves and the running status of the vacuum pumping pipe; drive and display the transmitting and running status of the charging rack 2; drive and display the running status of valves between the chambers and furnace doors; display the vacuum degree, pressure and heating temperature of each separate vacuum chamber; the running status of medium gas and the status of safety valve; actual cooling water, air pressure force, and the medium gas alarm; alarm management; displays all relevant process parameters (predetermined value and the actual value); parameter input; historical process parameters/data display and storage; all major components of the equipment can be operated through the display screen.

The product performance comparisons produced by the present invention process and the current process are as follows:

Comparison example: proportion blank at the weight ratio of 18% Nd, 8.5% Pr, 3% Dy, 1.02% B, 0.3% Al, and Fe as a balance, process melting, hydrogen crushing, jet mill and magnetic formation; sinter the compact thus formed in the single chamber evacuated sintering furnace equipped with protective glove chamber, heat to 430° C. then preserve heat and degas for 3 hours, the after the heat preservation, heat to 850° C., preserve heat for 2 hours, then heat to 1080° C. and vacuum sinter and preserve heat for 2 hours, then the vacuum degree reaches E-2 Pa, then respectively process aging at 900° C. for 2 hours and 500° C. for 4 hours.

### Example 1

Materials and proportions thereof adopted in the example 1 are the same as the comparison example, and the continuous sintering method and equipment for rare earth permanent magnetic alloy are adopted for sintering.

Specific steps of the continuous sintering method for rare earth permanent magnetic alloy comprise:

(1) packaging a press formed blank of rare earth permanent magnetic alloy powder to isolate from air, conveying to a preparation chamber 37, closing a door of the preparation chamber 37, vacuum pumping or charging insert gas to replace air in the preparation chamber 37;

when the preparation chamber 37 has a balanced pressure with a glove chamber 39, opening a 6# isolating valve 38 among chambers, conveying the packaged blank to the glove chamber, closing the 6# isolating valve 38 among chambers; and

unpacking the blank in the glove chamber 39 and putting the blank unpacked into a charging box 42, opening a 7# isolating valve among chambers 40, conveying the charging box 42 to a sealed transmission chamber 41, closing a valve among chambers, conveying the charging box 42 to a manipulator of a charging chamber 44,

wherein during the process mentioned above, oxygen content of each box and the charging chamber 44 is less than 500 PPm;

(2) conveying a vertical charging rack 2 suspended on a transmission to the charging chamber 44 via a valve of a sealed chamber which is in parallel with the sealed transmission chamber 41 and connected with the charging chamber 44, putting the charging box 42 into grids of the charging rack 2, opening a chamber-to-chamber isolating valve after charging, conveying the charging rack 2 suspended to a preheating chamber 16 via the valve, vacuum pumping, heating and maintaining temperature thereof, wherein the heating temperature in the preheating chamber 16 is 400˜500° C.;

(3) opening a 2# isolating valve 25 among a heating and de-airing chamber 26 which is in a vacuum state, conveying the charging rack 2 which is suspended and loaded with the charging box 42 therein to the heating and de-airing chamber 26, closing the 2# isolating valve 25, wherein temperature of a heating furnace in this step maintains at 400° C.˜900° C., the heating furnace is capable of processing heating and heat preservation in multiple stage, and has a vacuum degree of over 3 Pa;

(4) opening a 3# isolating valve 28, conveying the charging rack 2 which is suspended and loaded with the charging box 42 therein to a sintering chamber 29 which is in a vacuum state, closing the 3# isolating valve 28, and sintering at temperatures of 1020° C.˜1080° C.;

(5) opening a 4# isolating valve 31 among a cooling chamber 34, conveying the charging rack 2 which is suspended and loaded with the charging box 42 therein to the cooling chamber 34, closing the 4# isolating valve 31;

charging the cooling chamber 34 with nitrogen or argon, when a pressure of the cooling chamber 34 is 0.01 MPa˜0.19 MPa, starting a fan 33 for cooling the charging box 42 and the rare earth permanent magnetic alloy therein to a temperature of 80° C. below;

when the pressure of the cooling chamber 34 balances with the atmosphere, opening a discharging end door 35, conveying the charging rack 2 to a discharging end transition rack, closing the discharging end door 35, and removing the charging box 42 from the charging rack;

(6) when the charging box is removed from the charging rack, the charging rack enters a charging end transition rack via a loop line and the sealed chamber is charged to be balanced with the atmosphere, opening the charging end door to convey the charging rack to the sealed chamber, closing the charging end door and vacuum pumping to a pressure of 1 Pa, charging insert gas, when the sealed chamber has a balanced pressure with the charging chamber, opening the valve among chambers and conveying the charging rack to the charging chamber again to prepare for loading the charging box.

The continuous sintering method for rare earth permanent magnetic alloy, further comprises following steps of:

(7) connecting an aging chamber after the cooling chamber via the valve, conveying the charging rack to the aging chamber, heating for 2˜4 hours at a temperature of 800° C.˜900° C.

The continuous sintering method for rare earth permanent magnetic alloy further comprises following steps of:

(8) connecting a second cooling chamber 2 after the aging chamber, conveying the charging rack which is suspended and loaded with the charging box therein to the second cooling chamber 2;

charging the cooling chamber with nitrogen or argon, when a pressure of the cooling chamber is 0.01 MPa˜0.19 MPa, starting a fan for cooling the charging box and the rare earth permanent magnetic alloy therein to a temperature of 80° C. below;

when the pressure of the cooling chamber balances with the atmosphere, opening a discharging end door, conveying the charging rack to a discharging end transition rack, closing the discharging end door, and removing the charging box from the charging rack.

### Example 2

Materials and proportions adopted in the example 2 is the same as the comparison example, and the continuous sintering method and aging in the example 1 is adopted in the example 2. Vacuum pumping the preheating chamber, heating the preheating chamber to 400° C. when vacuum degree thereof is over 1 Pa, heating to 400° C., maintaining the temperature for 3 hours, heating in the heating and de-airing chamber at 450° C.˜800° C. in multiple stage, maintaining for 3 hours at 800° C., continuously heating when vacuum degree thereof reaches 3E-2 Pa, heating the sintering chamber to 1080° C. and sintering for 2 hours, when vacuum degree thereof reaches E-2 Pa processing aging with the aging process in the example 1.

### Example 3

Materials and proportions adopted in the example 3 is the same as the comparison example, and the continuous sintering method and aging in the example 1 is adopted. Vacuum pumping the preheating chamber, when vacuum degree thereof is over 1 Pa, heating to 500° C., maintaining the temperature for 3 hours, heating in the heating and de-airing chamber at 500° C.˜850° C. in multiple stage, maintaining for 4 hours at 850° C., continuously heating when vacuum degree thereof reaches 3E-2 Pa, heating the sintering chamber to 1080° C. and sintering for 2 hours, when vacuum degree thereof reaches E-2 Pa processing aging with the aging process in the example 1.

### Example 4

Materials and proportions adopted in the example 4 is the same as the comparison example, and the continuous sintering method and aging in the example 1 is adopted. Vacuum pumping the preheating chamber, when vacuum degree thereof is over 1 Pa, heating to 500° C., maintaining the temperature for 3 hours, heating in the heating and de-airing chamber at 500° C.˜900° C. in multiple stage, maintaining for 3 hours at 900° C., continuously heating when vacuum degree thereof reaches 3E-2 Pa, heating the sintering chamber to 1080° C. and sintering for 2 hours, when vacuum degree thereof reaches E-2 Pa processing aging with the aging process in the example 1.

| | Item | | | | | | |
|---|---|---|---|---|---|---|---|
| | | | Heating and | | | | |
| | Preheating | | de-airing | | Rema- | Coercive | Magnetic energy |
| | Temper- | | Temper- | | nence | force | product |
| | ature | Time | ature | Time | Br | Hcj | (BH) max |
| Number | (° C.) | (Hour) | (° C.) | (Hour) | (KGs) | (KOe) | (MGOe) |
| Comparison | 430 | 3 | 850 | 2 | 13.1 | 24.5 | 43.5 |
| example | | | | | | | |
| Example 1 | 430 | 3 | 850 | 2 | 13.2 | 25.7 | 44. |
| Example 2 | 400 | 3 | 800 | 3 | 13.4 | 25.9 | 45.5 |
| Example 3 | 500 | 3 | 850 | 4 | 13.6 | 26.5 | 46.5 |
| Example 4 | 500 | 3 | 900 | 3 | 13.6 | 26.8 | 46.5 |

It can be seen from the examples mentioned above that by the continuous sintering method, magnetic properties of the rare earth permanent magnetic alloy are improved, and production automation thereof is greatly improved as well.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A continuous sintering method for rare earth permanent magnetic alloy, comprising steps of:
(1) packaging a press formed blank of rare earth permanent magnetic alloy powder to isolate from air, conveying to a preparation chamber, closing a door of the preparation chamber, vacuum pumping or charging insert gas to replace air in the preparation chamber;
when the preparation chamber has a balanced pressure with a glove chamber, opening a 6# isolating valve among chambers, conveying the packaged blank to the glove chamber, closing the 6# isolating valve among chambers; and
unpacking the blank in the glove chamber and putting the blank unpacked into a charging box, opening a 7# isolating valve among chambers, conveying the charging box to a sealed transmission chamber, closing a valve among chambers, conveying the charging box to a manipulator of a charging chamber,
wherein during the process mentioned above, oxygen content of each chamber and the charging chamber is less than 500 PPm;
(2) conveying a vertical charging rack suspended on a transmission to the charging chamber via a valve of a sealed chamber which is in parallel with the sealed transmission chamber and connected with the charging chamber, putting the charging box into grids of the charging rack, opening a chamber-to-chamber isolating valve after charging, conveying the charging rack suspended to a preheating chamber via the valve, vacuum pumping, heating and maintaining temperature thereof, wherein the heating temperature in the preheating chamber is 400˜500° C.;
(3) opening a 2# isolating valve among a heating and de-airing chamber which is in a vacuum state, conveying the charging rack which is suspended and loaded with the charging box therein to the heating and de-airing chamber, closing the 2# isolating valve, wherein temperature of a heating furnace in this step maintains at 400° C.˜900° C., the heating furnace is capable of processing heating and heat preservation in multiple stage, and has a vacuum degree of over 3 Pa;
(4) opening a 3# isolating valve, conveying the charging rack which is suspended and loaded with the charging box therein to a sintering chamber which is in a vacuum state, closing the 3# isolating valve, and sintering at temperatures of 1020° C.˜1080° C.;
(5) opening a 4# isolating valve among a cooling chamber, conveying the charging rack which is suspended and loaded with the charging box therein to the cooling chamber, closing the 4# isolating valve;
charging the cooling chamber with nitrogen or argon, when a pressure of the cooling chamber is 0.01 MPa˜0.19 MPa, starting a fan for cooling the charging box and the rare earth permanent magnetic alloy therein to a temperature of 80° C. below;
when the pressure of the cooling chamber balances with the atmosphere, opening a discharging end door, conveying the charging rack to a discharging end transition rack, closing the discharging end door, and removing the charging box from the charging rack;
(6) when the charging box is removed from the charging rack, the charging rack enters a charging end transition rack via a loop line and the sealed chamber is charged to be balanced with the atmosphere, opening the charging end door to convey the charging rack to the sealed chamber, closing the charging end door and vacuum pumping to a pressure of 1 Pa, charging insert gas, when the sealed chamber has a balanced pressure with the charging chamber, opening the valve among chambers and conveying the charging rack to the charging chamber again to prepare for loading the charging box.

2. The continuous sintering method for rare earth permanent magnetic alloy, as recited in claim 1, further comprising a step of:
(7) connecting an aging chamber after the cooling chamber via the valve, conveying the charging rack to the aging chamber, heating for 2˜4 hours at a temperature of 800° C.˜900° C.

3. The continuous sintering method for rare earth permanent magnetic alloy, as recited in claim 2, further comprising a step of:
(8) connecting a second cooling chamber (2) after the aging chamber, conveying the charging rack which is suspended and loaded with the charging box therein to the second cooling chamber (2);
charging the cooling chamber with nitrogen or argon, when a pressure of the cooling chamber is 0.01 MPa˜0.19 MPa, starting a fan for cooling the charging box and the rare earth permanent magnetic alloy therein to a temperature of 80° C. below;
when the pressure of the cooling chamber balances with the atmosphere, opening a discharging end door, conveying the charging rack to a discharging end transition rack, closing the discharging end door, and removing the charging box from the charging rack.

4. A continuous sintering equipment for rare earth permanent magnetic alloy, comprising:
a preparation chamber, a glove chamber and a sealed transmission chamber which are provided one after another, and
a sealed chamber, a charging chamber, a preheating chamber, a heating and de-airing chamber, a sintering chamber and a cooling chamber which are provided one after another,
wherein the sealed chamber, the charging chamber, the preheating chamber, the heating and de-airing chamber, the sintering chamber and the cooling chamber respectively comprise a transmission provided on a top portion thereof,
wherein the charging rack is suspended on the transmission, a manipulator is provided in the charging chamber, each of the chambers are connected via chamber-to-chamber isolating valves, the sealed transmission chamber is connected with the charging chamber,
wherein a number of the preheating chamber, the heating and de-airing chamber, the sintering chamber and the cooling chamber is one or more.

5. The continuous sintering equipment for rare earth permanent magnetic alloy, as recited in claim 4, wherein the preheating chamber, the heating and de-airing chamber and the sintering chamber all have a vertical cuboid heating furnace provided therein, a thermal insulator is provided on an inner wall of the heating furnace, multiple groups of heaters are provided in the thermal insulator, the transmission is provided on an external of the heating furnace, a first thermal insulation board is provided on a top portion of the heating furnace.

6. The continuous sintering equipment for rare earth permanent magnetic alloy, as recited in claim 4, wherein the chamber-to-chamber isolating valve is a one-way sealed isolating gate valve, comprising: a valve body, a second air cylinder, multiple air cylinders or oil cylinders, a first valve plate, a front blank flange and a rear blank flange,
wherein the front blank flange and the rear blank flange are respectively provided on two corresponding sides of the valve body, the second air cylinder and a water cooling unit are provided on a top portion of an external of the front blank flange;
wherein the first valve plate which is parallel with two sides of the valve body is provided in the valve body, the first valve plate is suspended on a top portion in the valve body via a valve plate moving device, the valve moving device is rigidly connected with a cylinder end of a rod of the second air cylinder,
wherein a plurality of second rollers and a bottom guide rail are provided on a bottom of the first valve plate, a water cooling pipe or jacket is welded on the first valve plate, the water cooling pipe or jacket is connected with two sealed rigid cooling pipe shafts via a flexible pipe of the water cooling unit, the cooling pipe shafts is connected with the rod of the second air cylinder, so as to achieve a linkage,
wherein the first valve plate is relatively static to the cooling pipe shaft while moving, the multiple air cylinders or oil cylinders are respectively connected with two ends of the first valve plate, so as to lock the first valve plate;

7. The continuous sintering equipment for rare earth permanent magnetic alloy, as recited in claim 4, wherein a second electric motor is provided on a side wall of the cooling chamber, a heat-exchange box is provided in the cooling chamber, a plurality of honeycomb ducts are provided on a plate of the heat-exchange box on a first side, and a second side thereof has a heat exchanger provided thereon, an air outlet of the heat exchanger faces an air outlet of a fan, the fan is connected with a shaft of the second electric motor, an arc guide plate is provided on a periphery of an inner wall of the cooling chamber, an external of the cooling chamber is connected with a vacuum pumping pipe, a insert gas guiding pipe and a safety valve pipe, the vacuum pumping pipe is connected with the 5# vacuum equipment.

8. The continuous sintering equipment for rare earth permanent magnetic alloy, as recited in claim 4, wherein a wax collecting tank is provided in the preheating chamber for serving as a dewaxing chamber.

9. The continuous sintering equipment for rare earth permanent magnetic alloy, as recited in claim 4, wherein the transmission comprises a first electric motor, a chain, a gear pair, two bearing chocks, two parallel guide rails, two groups of first rollers, two first sprockets, a second sprocket and a chain plate,
wherein both of the first sprockets are provided on a hinge axis which passes through shell bodies of each chamber and extends outside the shell bodies, an output axis of the first electric motor is connected with the first sprocket via the chain, a first end of the two bearing chocks is respectively provided on a sprocket axis in the shell bodies, and a second end thereof is connected with an axis parallel with the sprocket axis, wherein the both hinge axis and the axis respectively have coupled gear pairs provided thereon, the second sprocket is provided on the sprocket axis inside the shell bodies, the two groups of first roller provided in the two parallel guide rail are connected via a roller axis thereof, the chain plate coupled with the second sprocket is provided on the roller axis, a second end of the chain plate is connected with the connecting rod of the charging rack.

10. The continuous sintering equipment for rare earth permanent magnetic alloy, as recited in claim 9, wherein the bearing chock is connected with a first end of a spring plate, and a second end of the spring plate is connected with the shell bodies of each chamber, wherein the spring plate bears a force during operation, in such a manner that the second sprocket is closely connected with the chain plate.

11. The continuous sintering equipment for rare earth permanent magnetic alloy, as recited in claim 4, wherein the preparation chamber, the glove chamber and the tunnel type sealed transmission chamber are all sealed chambers which are vacuum or filled by protective atmosphere, evacuation pipes are provided thereon for connecting the vacuum pumping pipe, and a charging line for insert gas is provided thereon for filling insert gas;
wherein an chamber-to-chamber isolating valve is provided between each two adjacent chambers, a first end of the preparation chamber has a chamber door, a manipulator for putting the charging box onto the charging rack of the charging chamber is provided in the sealed transmission chamber, the pressure gage and the vacuum gauge are provided in each of the chamber mentioned above, a pipe with balance valve is connected between each adjacent two chambers, so as to balance pressure of the two chambers thereby.

12. The continuous sintering equipment for rare earth permanent magnetic alloy, as recited in claim 12, wherein the chamber-to-chamber isolating valve comprises a valve chamber, a third cylinder and a second valve plate, a hinge plate, a connecting rod, a third roller, a guide rail and a striking block which are provided in the third cylinder,
wherein the second valve plate is connected to the hinge plate via a plurality of connecting rods, a guide rail is provided in the valve chamber, the third roller which is capable of sliding along the guide rail is provided on the hinge plate, the third cylinder is provided on an external of the valve chamber, and a cylinder rod thereof is inserted into the valve chamber to connect the hinge plate, the striking block is provided on a valve deck in the valve chamber, a rubber ring is provided on an end close to a flange beside a valve port on the second valve plate, the third cylinder drives the hinge plate to move along the guide rail, the second valve plate strikes the striking block, the connecting rod pushes the second valve plate to move towards the flange beside the valve port, so as to compress the second rubber ring for accomplishing an effect of isolating and sealing.
